(19) United States
(12) Patent Application Publication
(10) Pub. No.: US 2007/0291811 A1
(43) Pub. Date: Dec. 20, 2007

(54) Entangled Photon Source

(76) Inventor: Ralph S. Conti, Ypsilanti, MI (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/420,647

(22) Filed: May 26, 2006

(51) Int. Cl. H01S 3/08

(52) U.S. Cl. 372/98

(57) ABSTRACT

A system for and method of efficiently generating high-intensity entangled photons are disclosed. The system and method may advantageously use an optical ring cavity that is resonant in the frequency of a pump light beam.

### FIELD OF THE INVENTION

The present invention relates to the field of photonics. More particularly, the invention relates to a system for and method of efficiently generating entangled photons. Embodiments of the invention may be used to efficiently generate entangled photon pairs or multiply-entangled photons.

### BACKGROUND OF THE INVENTION

Two photons quantum-mechanically entangled together are referred to as an entangled-photon pair, or biphoton. Traditionally, the two photons comprising a biphoton are called “signal” and “idler” photons. The designation of which photon is referred to as “signal” and which is referred to as “idler” is arbitrary. The constituent photons of an entangled photon pair have a connection between their respective properties. Measuring properties of one photon of an entangled-photon pair determines properties of the other photon, even if the two photons are separated by a distance. As understood by those of ordinary skill in the art and by way of non-limiting example, the quantum mechanical state of an entangled-photon pair cannot be factored into a tensor product of two individual quantum states.

In general, more than two photons may be entangled together. More than two photons entangled together are referred to as “multiply-entangled” photons. Measuring properties of one or more photons in a set of multiply-entangled photons restricts properties of the rest of the photons in the set. As understood by those of ordinary skill in the art and by way of non-limiting example, the quantum mechanical state of a set of n>2 multiply-entangled photons cannot be factored into a product of m separate states, where 1<m≦n. The term “entangled photons” refers to both biphotons and multiply-entangled photons.

### BRIEF DESCRIPTION OF THE DRAWINGS

The novel features that are considered characteristic of the invention are set forth with particularity in the appended claims. The invention itself, however, both as to its structure and operation together with the additional objects and advantages thereof are best understood through the following description of exemplary embodiments of the present invention when read in conjunction with the accompanying drawings.

FIG. 1 is a schematic diagram depicting a linear entangled photon source according to an embodiment of the present invention;

FIG. 2 is a schematic diagram depicting a rectangular ring cavity entangled photon source according to an embodiment of the present invention;

FIG. 3 is a schematic diagram depicting a triangular ring cavity entangled photon source featuring a nonlinear crystal according to an embodiment of the present invention; and

FIG. 4 is a schematic diagram depicting a triangular ring cavity entangled photon source featuring a wave mixing crystal according to an embodiment of the present invention.

### DETAILED DESCRIPTION OF THE INVENTION

In general, techniques for generating entangled photons are known. However, prior art techniques typically suffer from inefficient parametric down-conversion, typically on the order of 10⁻⁶ entangled photon sets generated per pump photon into all angles and colors. Naïvely using an optical cavity resonant in a frequency of one or more components of the entangled photons, as in the case of an optical parametric oscillator, would destroy temporal photon entanglement because the individual residence time in the cavity of an entangled photon component is unknowable. The naive approach is therefore unsuitable.

However, recycling pump beam photons in an optical cavity resonant in the pump frequency retains the full temporal entanglement of spontaneous parametric down-conversion. Certain embodiments of the present invention employ this technique. Further, longer crystals generally have higher efficiency and a tighter correlation between angle and color. Any, or a combination, of techniques for enhancing efficiency, such as longer crystals, multiple crystals, multiple non-linear crystals separated by birefringent crystals, periodically poled crystals, and differential phase shifts, may be used in conjunction with optical cavity pump beam frequency resonance to optimize efficiency.

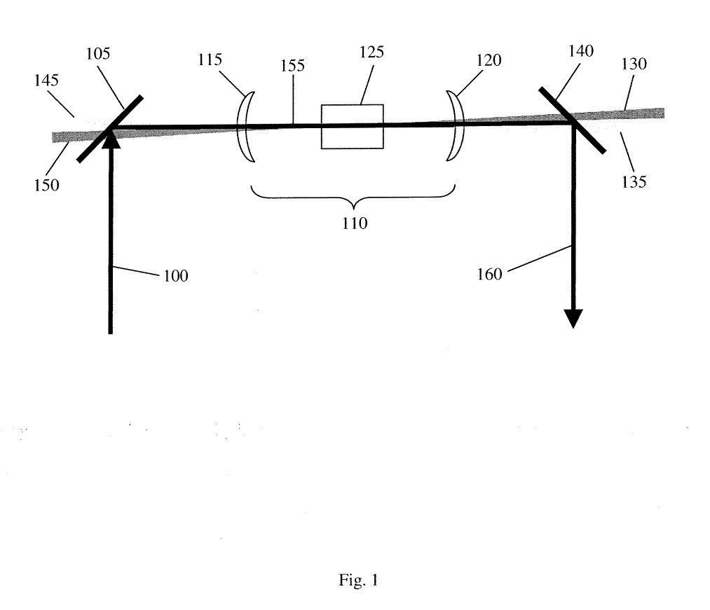

FIG. 1 is a schematic diagram depicting a linear entangled photon source according to an embodiment of the present invention. Pump beam 100, which may be generated by a laser external to the entangled photon source, is directed to mirror 105. Beam 100 may by way of non-limiting example, be ultraviolet. Mirror 105 is configured for high reflectivity at the frequency of beam 100 and low reflectivity at the frequencies of the generated entangled photons. By way of non-limiting example, mirror 105 may be a dichroic mirror that has high reflectivity at ultraviolet frequencies and low reflectivity at visible or infrared frequencies. Mirror 105 thus reflects most of beam 100 to optical cavity 110 as reflected beam 155.

Optical cavity 110 may be, by way of non-limiting example, a Fabry-Perot confocal cavity whose mirrors 115, 120 have high reflectivity at the frequency of beam 155 and low reflectivity at the frequency or frequencies of the component entangled photons. Optical cavity 110 is preferably resonant in the frequency of beam 100.

An entangled photon generating material 125 is disposed within optical cavity 110. By way of non-limiting example, such a material may be a nonlinear crystal such as beta barium borate (“BBO”). As a result of receiving reflected beam 155, entangled photon generating material 125 outputs signal photons 130 and idler photons 135, some of which pass through mirror 120. Mirror 140 transmits a portion of the entangled photons 130, 135 and reflects a portion of the pump laser beam photons 160. That is, mirror 140 has similar or identical reflection and transmission characteristics to mirror 105.

A portion of entangled photons exits optical cavity 110 at the same side on which pump laser beam 100 enters. Thus, signal photons 150 and idler photons 145 pass through mirrors 115 and 105 and may be used in any application requiring entangled photons. A second portion of entangled photons 130, 135 exits optical cavity 110 through mirrors 120 and 140. Accordingly, the embodiment of FIG. 1 produces entangled photons in two directions: to the left (145, 150) and to the right (130, 135). Of course, the designations “left” and “right” are purely arbitrary; the embodiment of FIG. 1 may be positioned to direct its entangled photons in any direction.

The embodiment of FIG. 1 may be used to generate entangled photons of various frequencies. One or more apertures, for example, may be positioned along the paths of signal photons 130 and idler photons 135 in order to select signal and idler photons of a particular frequency combination. In particular, the embodiment of FIG. 1 (as well as the other embodiments discussed herein) may be used to generate degenerate or non-degenerate entangled photons.

This disclosure proceeds with an analytical discussion relevant to the embodiments of the present invention presented herein. Unless otherwise indicated, all units are CGS. The power of the signal photons that are emitted from an entangled photon generating material within angle θ and frequency interval dωₛ may be represented as, by way of non-limiting example:

$$dP ( {ω}_{s} ) = \frac{{n}_{s}^{2} {n}_{i} {ℏω}_{s}^{3} {g}_{0}^{2} {l}^{2} A}{16 {π}^{2} {c}^{2}} {\int }_{0}^{θ} \frac{{sinh}^{2} \{ {[ {g}_{0}^{2} - {( - a Δω + b {ψ}_{s}^{2} )}^{2} ]}^{1 / 2} l / 2 \}}{{\{ {[ {g}_{0}^{2} - {( - a Δω + b {ψ}_{s}^{2} )}^{2} ]}^{1 / 2} l / 2 \}}^{2}} {ψ}_{s} d {ψ}_{s} . \qquad ( 1 )$$

In equation (1), nₛ represents the index of refraction of the nonlinear crystal for the signal photons, nᵢ represents the index of refraction of the nonlinear crystal for the idler photons, ωₛ represents the signal photons' angular frequency, l represents the length of the nonlinear crystal, A represents the cross-sectional area of the non-linear crystal, [symbol] is Planck's constant and c represents the speed of light in a vacuum. Further, in equation (1),

$$a = [ {( \frac{d {k}_{s}}{d {ω}_{s}} )}_{{ω}_{s}^{0}} - {( \frac{d {k}_{i}}{d {ω}_{i}} )}_{{ω}_{i}^{0}} ] and b = \frac{{k}_{s} {k}_{p}}{2 {k}_{i}} ,$$

where kₛ represents the magnitude of the signal photons' momentum vector, kᵢ represents the magnitude of the idler photons' momentum vector and kₚ represents the magnitude of the pump photons' momentum vector. The term ψₛ represents the angle between the signal photons' momentum vector and the pump photons' momentum vector. The term Δω is defined as Δω=ωₛ−ωₛ⁰=ωᵢ⁰−ωᵢ, where ωₛ⁰ represents the angular frequency for which there is a phase match between the signal photons and the pump photons and ωᵢ⁰ represents the angular frequency for which there is a phase match between the idler photons and the pump photons. Note that ωₛ⁰ and ωᵢ⁰ are phase-matched in the direction of the pump beam. Further describing the parameters of equation (1), the parametric gain threshold g₀ for the downconversion process may be represented according to, by way of non-limiting example,

$${g}_{0}^{2} = ( \frac{4 {ω}_{s}^{2} {ω}_{i}^{2}}{{k}_{sz} {k}_{iz}} ) {( \frac{2 π}{{c}^{2}} )}^{2} {χ}_{eff}^{2} {p}_{2}^{} ,$$

where k_{sz} represents the magnitude of the z-axis (i.e., parallel to the pump beam) component of kₛ, k_{iz} represents the magnitude of the z-axis component of kᵢ, χ_{eff} represents the effective second-order nonlinear susceptibility of the nonlinear crystal for the given system and [symbol] represents the electric field of the pump photons. Note that the effective second-order nonlinear susceptibility may be represented as χ_{eff}=χ_{BBO} sin²θₚ, where χ_{BBO} represents the nonlinear second-order susceptibility of the nonlinear crystal for pump beam polarization parallel to the crystal's preferred axis and θₚ represents the angle between the pump beam and the preferred axis of the crystal. The measure of phase mismatch, Δₖ is defined as Δk=k_{pz}−k_{sz}−k_{iz}. Note that Δk≅−aΔω+bψₛ².

The power of the pump beam for a single pass through a non-linear crystal may be represented as, by way of non-limiting example:

$${P}_{in} = \frac{{n}_{p} cA {in}_{2}^{}}{4 π} . \qquad ( 2 )$$

In equation (2), the term [symbol] ᵢₙ represents the pump photons' energy as they enter the nonlinear crystal and nₚ represents the index of refraction of the nonlinear crystal for the pump photons. The remaining terms in equation (2) are defined as above in reference to equation (1). For an optical cavity, the stored power may be represented as, by way of non-limiting example:

$${P}_{p} = {QP}_{in} = \frac{{n}_{p} cAQ {in}_{2}^{}}{4 π} . \qquad ( 3 )$$

In equation (3), the parameter Q represents the cavity quality factor. The remaining terms in equation (3) are as defined above in reference to equations (1) and (2). Also for the case of an optical cavity, the parametric gain threshold g₀ for the downconversion process may be represented according to, by way of non-limiting example:

$${g}_{0}^{2} = ( \frac{4 {ω}_{s} {ω}_{i}}{{n}_{s} {n}_{i}} ) {( \frac{2 π}{c} )}^{2} {χ}_{eff}^{2} \frac{4 π {P}_{p}}{{An}_{p} c} = {( \frac{4 π}{c} )}^{3} ( \frac{{ω}_{s} {ω}_{i}}{{n}_{s} {n}_{i} {n}_{p}} ) {χ}_{eff}^{2} \frac{{P}_{p}}{A} . \qquad ( 4 )$$

In equation (4), the term Pₚ represents the power of the pump beam. The remaining terms in equation (4) are as defined above in reference to equations (1)-(3). For the case of an optical cavity, the power of the signal photons that are emitted from an entangled photon generating material within angle θ and frequency interval dωₛ may be represented as, by way of non-limiting example:

$$dP ( {ω}_{s} ) = \frac{4 π {n}_{s} {ℏω}_{s}^{4} {ω}_{i} {l}^{2} {χ}_{eff}^{2} {P}_{p}}{{n}_{p} {c}^{5}} {\int }_{0}^{θ} \frac{{sinh}^{2} \{ {[ {g}_{0}^{2} - {( - a Δω + b {ψ}_{s}^{2} )}^{2} ]}^{1 / 2} l / 2 \}}{{\{ {[ {g}_{0}^{2} - {( - a Δω + b {ψ}_{s}^{2} )}^{2} ]}^{1 / 2} l / 2 \}}^{2}} {ψ}_{s} d {ψ}_{s} . \qquad ( 5 )$$

The terms in equation (5) are as defined above in reference to equations (1)-(4). Noting that ωₛ and ωᵢ vary relatively slowly compared to the phase match function, the ratio of signal photon stream power Pₛ to pump photon stream power Pₚ for an optical cavity may be represented as, by way of non-limiting example:

$$\frac{{P}_{s}}{{P}_{p}} = \frac{4 π {n}_{s} {ℏω}_{s}^{4} {ω}_{i} {l}^{2} {χ}_{eff}^{2}}{{n}_{p} {c}^{5}} {\int }_{- ∞}^{∞} d {ω}_{s} {\int }_{0}^{θ} \frac{{sinh}^{2} \{ {[ {g}_{0}^{2} - {( - a Δω + b {ψ}_{s}^{2} )}^{2} ]}^{1 / 2} l / 2 \}}{{\{ {[ {g}_{0}^{2} - {( - a Δω + b {ψ}_{s}^{2} )}^{2} ]}^{1 / 2} l / 2 \}}^{2}} {ψ}_{s} d {ψ}_{s} . \qquad ( 6 )$$

In equation (6), the term a may be approximated according to

$$a ≅ \frac{{n}_{s}}{c} - \frac{{n}_{i}}{c} .$$

### The remaining terms in equation (6) are as defined above in reference to equations (1)-(5).

Assuming for illustrative purposes that g₀ is relatively small, the power ratio may be approximated as, by way of non-limiting example:

$$\frac{{P}_{s}}{{P}_{p}} ≅ \frac{4 π {n}_{s} {ℏω}_{s}^{4} {ω}_{i} {l}^{2} {χ}_{eff}^{2}}{{n}_{p} {c}^{5}} ( \frac{2}{\vert a \vert l} ) {\int }_{- ∞}^{∞} d ( \frac{al Δω}{2} ) {\int }_{0}^{θ} \frac{{sin}^{2} \{ ( - a Δω + b {ψ}_{s}^{2} ) l / 2 \}}{{\{ ( - a Δω + b {ψ}_{s}^{2} ) l / 2 \}}^{2}} {ψ}_{s} d {ψ}_{s} \\ \frac{{P}_{s}}{{P}_{p}} = \frac{4 π {n}_{s} {ℏω}_{s}^{4} {ω}_{i} {l}^{2} {χ}_{eff}^{2}}{{n}_{p} {c}^{5}} ( \frac{2}{\vert a \vert l} ) π {\int }_{0}^{θ} {ψ}_{s} d {ψ}_{s} \\ \frac{{P}_{s}}{{P}_{p}} = \frac{4 {π}^{2} {n}_{s} {ℏω}_{s}^{4} {ω}_{i} {l}^{2} {χ}_{eff}^{2}}{{n}_{p} {c}^{5}} ( \frac{2}{\vert a \vert l} ) ( \frac{{θ}^{2}}{2} ) \\ \frac{{P}_{s}}{{P}_{p}} = \frac{4 {π}^{2} {n}_{s} {ℏω}_{s}^{4} {ω}_{i} l {χ}_{eff}^{2} {θ}^{2}}{\vert a \vert {n}_{p} {c}^{5}} . \qquad ( 7 )$$

Finally, the rate of signal photons produced for a given pump photon power Pₚ may be represented as, by way of non-limiting example:

$${R}_{s} = \frac{4 {π}^{2} {n}_{s} {ω}_{s}^{3} {ω}_{i} l {θ}^{2} {χ}_{eff}^{2}}{\vert {n}_{s} - {n}_{i} \vert {n}_{p} {c}^{4}} {P}_{p} = \frac{4 {π}^{2} {n}_{s} {ω}_{s}^{3} {ω}_{i} l {θ}^{2} {χ}_{eff}^{2}}{\vert {n}_{s} - {n}_{i} \vert {n}_{p} {c}^{4}} {QP}_{in} . \qquad ( 8 )$$

Note that Rₛ is equal to Pₛ/ [symbol] ωₛ by definition. Thus, entangled photon conversion efficiency by certain entangled photon generating materials is optimized when the cavity quality factor Q is very high and the cavity losses are dominated by entangled photon conversion. Note that when cavity losses are dominated by conversion to entangled photons, the result is a near-total conversion of pump power to biphotons at all phase-matched frequencies and angles.

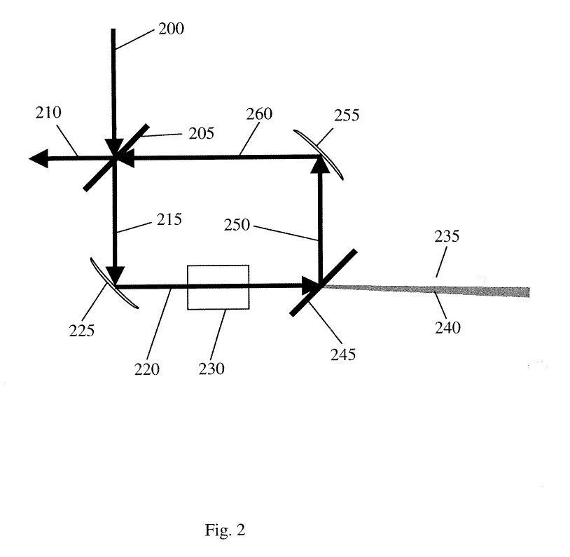

FIG. 2 is a schematic diagram depicting a rectangular ring cavity entangled photon source according to an embodiment of the present invention. Pump laser beam 200, which may be ultraviolet by way of non-limiting example, is directed at mirror 205. Mirror 205 is configured to reflect 99% of ultraviolet light. Thus, a portion 215 of beam 200 passes through mirror 205 and a portion is reflected as beam 210. Mirror 225, which is configured to reflect 100% of ultraviolet light, reflects beam 215 as beam 220.

Beam 220 intercepts an entangled photon generating material 230 such as, by way of non-limiting example, a non-linear crystal (e.g., BBO). Material 230 converts a portion of beam 220 into entangled photons. A portion of the entangled photons comprising signal photons 235 and idler photons 240 passes through mirror 245, which is preferably configured to reflect 100% of ultraviolet light and transmit 100% of visible and infrared light. Accordingly, mirror 245 reflects beam 220 to mirror 255 as beam 250. Mirror 255, in turn, reflects beam 250 such that reflected beam 260 reaches mirror 205.

Mirror 205 is aligned such that the reflected portion of beam 260 is aligned co-linearly and phased to constructively interfere with beam 215. Mirror 215 is placed such that the transmitted portion of beam 260 destructively interferes with beam 210. Accordingly, nearly all (e.g., greater than 99%) of beam 200 enters the optical ring cavity, with only a small portion (e.g., less than 1%) leaving as beam 210. Moreover, nearly all of the power circulating inside the optical ring cavity is converted into entangled photons 235 and 240.

The optical ring cavity of the embodiment of FIG. 2 is resonant in the frequency of the pump beam 200. In particular, the functional perimeter of the optical ring cavity, as measured by the length of the path that beams 215, 220, 250 and 260 travel, is an integer multiple of the wavelength of pump beam 200. Further, the pump beams and the signal and idler beams are preferably phased matched.

As with other embodiments discussed herein, the entangled photons produced by the embodiment of FIG. 2 may be screened to select signal photons and idler photons of particular frequencies. In general, a user may select degenerate or non-degenerate entangled photons using standard optical components such as gratings or apertures.

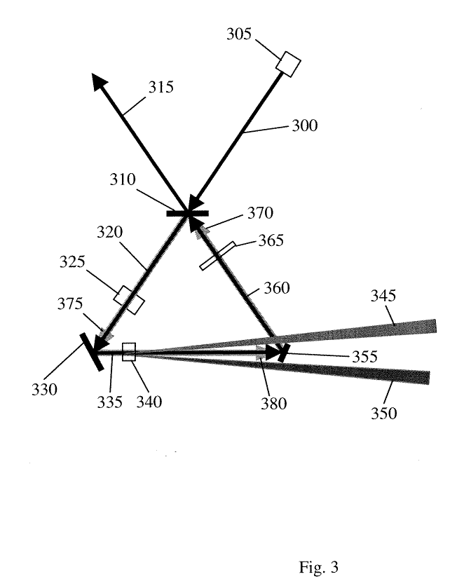

FIG. 3 is a schematic diagram depicting a triangular ring cavity entangled photon source featuring a nonlinear crystal according to an embodiment of the present invention. In this embodiment, external cavity CW diode laser 305 generates (by way of non-limiting example) 778 nanometer (“nm”) wavelength infrared beam 300. Laser 305 may be physically located in the same or different housing as that which contains the ring cavity. Mirror 310 is selected to reflect 100% of 389 nm light and 99.9% of 778 nm light. Therefore, while part of beam 300 reflects off mirror 310 as beam 315, a portion passes through mirror 310 and enters the optical ring cavity as beam 320. Beam 320 intercepts type-I doubling crystal 325, which converts a portion of 778 nm wavelength beam 320 into 389 nm wavelength beam 375. It is beam 375 and its reflections that produce entangled photons in the embodiment of FIG. 3. Thus, beam 375 and its reflections serve as the beam that pumps the entangled photon generating material. Beams 320 and 375 reflect off standard optical mirror 330, resulting in beams 335 and 380, respectively.

Entangled photon generating material 340 (e.g., BBO), receives beams 335 and 380 and converts a portion of 389 nm beam 380 into signal photons 345 and idler photons 350. Thus, entangled photon generating material 340 downconverts a portion of beam 380 into entangled photons 345, 350. Beams 335 and 380 reflect off mirror 355 as beams 360 and 370, respectively, whereas mirror 355 transmits entangled photons 345, 350.

By way of non-limiting example, mirror 355 may include dichroic glass selected to reflect beams 335 and 380 and transmit lower-frequency entangled photons 345, 350. Alternately, mirror 355 may be a conventional optical mirror sized and shaped so as to reflect beams 335 and 380 without impinging on the paths of signal photons 345 or idler photons 350. Entangled photons 345, 350 thus exit the optical cavity ring and may be used for any purpose that requires or utilizes entangled photons. In particular, optical components (by way of non-limiting examples, gratings or apertures) may be used to select entangled photon pairs of various energy distributions between their constituent signal photons and idler photons. Degenerate or non-degenerate entangled photon pairs may be selected.

Upon being reflected by mirror 355, 778 nm beam 360 and 389 nm beam 370 pass through dispersive tuning wedge 365, which allows both 389 nm wavelength light and 778 nm wavelength light to be resonant within the ring cavity. Most of beam 370 and substantially all of any remaining beam 360 are reflected off mirror 310 so as to be aligned co-linearly with beams 320 and 375. Beams 360 and 370 are reflected off of mirror 310 so as to constructively interfere with beams 320 and 375, respectively. Moreover, the transmitted portion of beam 360 destructively interferes with reflected beam 315. Accordingly, virtually all (e.g., greater than 99%) of the power of beam 300 enters and remains in the optical ring cavity, except that which is converted into entangled photons.

In general, both 389 nm and 778 nm wavelength light are resonant within the ring cavity of FIG. 3. Thus the distance traveled by 778 nm beams 320, 335 and 360 within the cavity is an integer multiple of 778 nm, and the distance traveled by 389 nm beams 375, 380 and 370 is an integer multiple of 389 nm. The optical ring cavity is further configured such that the beams of various frequencies are in phase.

The embodiment of FIG. 3 has the feature that the light used to produce the entangled photons is initially produced inside the optical ring cavity. That is, the light that non-linear crystal 340 converts into signal photons 345 and idler photons 350 is 389 nm light 375, 380 and 370, as produced by doubling crystal 325. This light ideally only exits the optical ring cavity via conversion into entangled photons.

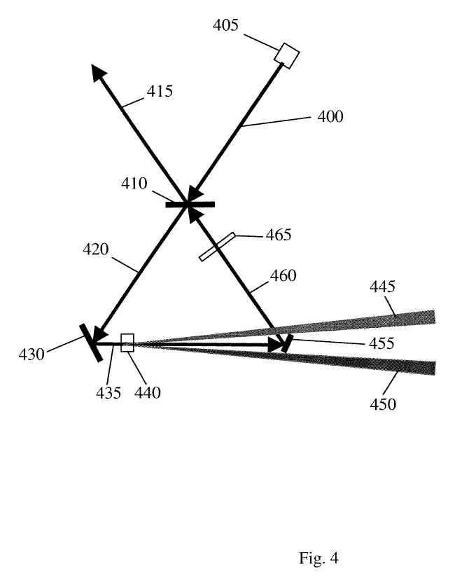

FIG. 4 is a schematic diagram depicting a triangular ring cavity entangled photon source featuring a 4-wave mixing crystal according to an embodiment of the present invention. Similar to the embodiment of FIG. 3, diode laser 405 generates beam 400 of 778 nm wavelength coherent light and passes it to mirror 410, which is constructed to reflect 99.9% of 778 nm light. A portion of beam 400 reflects off mirror 410 as reflected beam 415, and a portion enters the optical ring cavity as beam 420. Beam 420 reflects off mirror 430, resulting in beam 435, which intercepts 4-wave mixing crystal 440.

Crystal 440 generates signal photons 445 and idler photons 450 from beam 420 via 4-wave mixing. In this embodiment, the sum of energies of a biphoton is equal to the sum of energies of two pump photons. Mirror 455 reflects any remaining beam 435 that exits crystal 440 while allowing entangled photons 445, 450 to pass. In particular, dichroic mirror 455 may be constructed to reflect 778 nm light and allow lower and higher frequency light to pass. Alternately, mirror 455 may be sized and shaped so as to reflect beam 435 without blocking desirable entangled photons 445, 450. The entangled photons 445, 450 that exit the optical ring may be selected as degenerate or non-degenerate using standard optical components such as gratings or apertures. In particular, the embodiment of FIG. 4 may produce entangled photons having any selected energy distribution among their component photons; that is, both degenerate and non-degenerate entangled photons may be produced. In the case of degenerate entangled photons, it is preferable to use a selectively sized and shaped mirror because the frequency of each entangled photon constituent is equal to the frequency of a pump photon. Beam 435 reflects off mirror 455 as beam 460. Beam 460, in turn, passes through dispersive tuning wedge 465, which may be used to tune the optical ring cavity to resonance.

Most of the light exiting crystal 465 reflects off of mirror 410 and is aligned co-linearly and in-phase with beam 420. However, a portion of beam 460 exits the optical cavity ring so as to destructively interfere with beam 415. Accordingly, virtually all (e.g., greater than 99%) of beam 400 enters and remains in the optical ring cavity, except that which is converted into and leaves the cavity as entangled photons 445 and 450.

Note that, in the embodiments of FIGS. 2-4, light circulates in one direction within the ring cavity. Considering the embodiment of FIG. 2 by way of non-limiting example, beams 215, 220, 250 and 260 travel in a clockwise direction only. The optical ring cavity defined by beams 215, 220, 250 and 260 is topologically equivalent to a closed loop. Light flows in one direction (clockwise) in this loop. The optical ring cavity of the embodiment of FIG. 3 is also configured such that light flows in one direction within the ring cavity. In particular, beams 320, 335 and 360 flow counter-clockwise, as do beams 375, 380 and 370. The embodiment of FIG. 4 is similarly topologically equivalent to a closed loop in which light flows in one direction.

The embodiments of FIGS. 2-4 have many advantageous features. For example, in these embodiments, because light circulates in only one direction, the entangled photons exit in only one direction. That is, the entangled photons are produced in a single cone, which is represented in FIG. 2, for example, by signal photons 235 and idler photons 240. In these embodiments and under ideal conditions, all of the circulating power exits the ring cavities as entangled photons. That is, the ring cavity embodiments as disclosed herein are nearly 100% efficient in converting the pump beam into entangled photons in practice.

Ring cavity embodiments, such as those of FIGS. 2-4, stand in contrast to linear embodiments in which entangled photons exit in two directions. In the linear embodiment of FIG. 1, for example, entangled photons exit to the right (signal photons 130 and idler photons 135) and to the left (signal photons 150 and idler photons 145). In such embodiments, the linear cavity contains standing waves, which may be viewed as two oppositely-directed traveling waves, each having power at most one-half of the total circulating power. Thus, in the embodiment of FIG. 1, the entangled photons that exit to the left 145, 150 have half of the total circulating power, as do the entangled photons exiting to the right 130, 135. Because of phase space considerations that follow from the Liouville Theorem on statistical mechanics, these two sets of entangled photons may not be combined to achieve twice the intensity while retaining their entanglement. That is, there is no way to improve the power of linear cavity embodiments by combining their entangled photon beams while retaining photon entanglement. Accordingly, linear cavity embodiments in which entangled photons exit in two directions are at most 50% efficient in converting the pump beam into entangled photons.

In some embodiments of the present invention, multiply-entangled photons may be produced. By way of non-limiting example, entangled photon triples (three photons entangled together) or quadruples (four photons entangled together) may be produced. Multiply-entangled photons consisting of greater than four photons may also be produced. By way of non-limiting example, this may be accomplished by using crystals that allow higher order processes to occur (e.g., χ⁽³⁾, χ⁽⁴⁾, etc.).

A variety of different entangled photon generating materials may be used in embodiments of the present invention. By way of non-limiting example, entangled photons may be produced according to types I or II parametric down-conversion. Furthermore, any nonlinear crystal, not limited to BBO, may be used. Other ways to produce entangled photons include: 4-wave (or higher order) mixing crystals, excited gasses, materials without inversion symmetry, and generally any properly phase-matched medium. Furthermore, the entangled photons are not limited to any particular wavelength or frequency. Biphotons whose constituent signal and idler photons are orthogonally polarized may be used as well as biphotons whose constituent signal and idler photons are polarized in parallel.

Embodiments of the present invention may include coherent light generating material within the optical cavity. This may be accomplished in analogy to the construction of ring cavity lasers, known to those of ordinary skill in the art. In such embodiments, the pump beam is generated entirely within the ring cavity. Further, in such embodiments and by way of non-limiting examples, dispersive tuning wedges, gratings, prisms, inter-cavity etalons, interference filters and birefringent tuning elements may be used to assist in narrowing the frequency of the pump beam.

Embodiments of the present invention may employ various optics to select component entangled photons of particular frequencies. By way of non-limiting example, a beam containing entangled photons (e.g., signal photons and idler photons of entangled photon pairs) may be directed to a set of apertures, which select beams that respectively include constituent photons of chosen frequencies. Such apertures may be formed according to techniques taught in Boeuf et al., Calculating Characteristics of Non-collinear Phase-matching in Uniaxial and Biaxial Crystals (draft Aug. 27, 1999), available from the National Bureau of Standards. By way of non-limiting example, apertures at ±3° from center may be used to select degenerate biphotons. Interference filters may further distill the chosen component photons from the light that passes through the apertures.

The particular optical manipulation devices depicted herein are illustrative and representative and not meant to be limiting. By way of non-limiting example, mirrors, apertures, filters, lenses, and particular lasers disclosed herein may be replaced with devices known to those of ordinary skill in the art.

For the embodiments described herein, portions of one embodiment may be substituted, replaced, or inserted into other embodiments. That is, the teachings disclosed herein should be viewed collectively, with each embodiment capable of employing technologies drawn from other embodiments.

Certain quantities described herein are probabilistic. Thus, such quantities must be viewed as being typical, yet subject to variation. Further, most of the observations and measurements discussed herein are subject to noise of various forms from various sources. Probabilistic quantities are typically subjected to statistical analysis, known in the art, to ascertain their reliability and assist in drawing conclusions.

While the invention has been shown and described with reference to a particular embodiment thereof, it will be understood to those skilled in the art, that various changes in form and details may be made therein without departing from the spirit and scope of the invention.

What is claimed is:

1. A system for producing entangled photons, the system comprising:
an optical ring cavity;
at least one entangled photon generating material disposed within the optical ring cavity;
wherein the at least one entangled photon generating material is configured to receive coherent light within the optical ring cavity; and
wherein the optical ring cavity is configured to emit entangled photons produced by the at least one entangled photon generating material.

2. The system of claim 1 wherein the optical ring cavity is configured in a shape selected from the group consisting of: triangle and rectangle.

3. The system of claim 1 wherein the entangled photon generating material is selected from the group consisting of: beta barium borate, a liquid, a crystal, a glass, a gas, a material without inversion symmetry, a properly phase-matched medium, and means for n-wave mixing for n≧1.

4. The system of claim 1 wherein the optical ring cavity comprises a mirror configured to receive the coherent light and transmit at least a portion of the coherent light.

5. The system of claim 1 wherein the optical ring cavity further comprises a coherent light source included within the cavity.

6. The system of claim 1 further comprising a coherent light source external to the optical ring cavity.

7. The system of claim 1 wherein the optical cavity further comprises at least one component selected from the group consisting of: a grating, a prism, an inter-cavity etalon, an interference filter, a tuning wedge, multiple entangled photon generating material members, a birefringent crystal, periodically poled crystals, means for differential phase shift, a doubling crystal, and means for selecting entangled photons of a selected frequency distribution.

8. The system of claim 1 further configured to produce non-degenerate entangled photons.

9. The system of claim 1 further configured to produce multiply-entangled photons.

10. The system of claim 1 wherein the optical ring cavity is resonant at a frequency of the coherent light.

11. The system of claim 10 wherein the optical ring cavity is further resonant in a frequency different from the frequency of the coherent light.

12. A method of producing entangled photons, the method comprising:
directing coherent light to an entangled photon generating material disposed within an optical ring cavity; and
receiving entangled photons emitted from the optical ring cavity.

13. The method of claim 12 wherein the optical ring cavity is configured in a shape selected from the list consisting of: triangle and rectangle.

14. The method of claim 12 wherein the entangled photon generating material is selected from the group consisting of: beta barium borate, a liquid, a crystal, a glass, a gas, a material without inversion symmetry, a properly phase-matched medium, and means for n-wave mixing for n≧1.

15. The method of claim 12 wherein the optical ring cavity comprises a mirror configured to receive the coherent light and transmit at least a portion of the coherent light.

16. The method of claim 12 wherein the optical ring cavity further comprises a coherent light source included within the cavity.

17. The method of claim 12 wherein the step of directing comprises directing coherent light to the optical ring cavity from a source external to the optical ring cavity.

18. The method of claim 12 wherein the optical cavity further comprises at least one component selected from the group consisting of: a grating, a prism, an inter-cavity etalon, an interference filter, a tuning wedge, multiple entangled photon generating material members, a birefringent crystal, periodically poled crystals, means for differential phase shift, a doubling crystal, and means for selecting entangled photons of a selected frequency distribution.

19. The method of claim 12 further comprising selecting non-degenerate entangled photons.

20. The method of claim 12 wherein the step of receiving further comprises receiving multiply-entangled photons.

21. The method of claim 12 wherein the optical ring cavity is resonant at a frequency of the coherent light.

22. The method of claim 21 wherein the optical ring cavity is further resonant in a frequency different from the frequency of the coherent light.
